(19) United States
(12) Patent Application Publication
(10) Pub. No.: US 2009/0024462 A1
(43) Pub. Date: Jan. 22, 2009

(54) METHOD AND SYSTEM FOR PROVIDING TARGETED OFFERS BASED ON A CREDIT ATTRIBUTE

(75) Inventor: Kenneth Lin, Oakland, CA (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: CREDIT KARMA, INC., San Francisco, CA (US)

(21) Appl. No.: 11/778,203

(22) Filed: Jul. 16, 2007

(51) Int. Cl. G06Q 30/00

(52) U.S. Cl. 705/14

(57) ABSTRACT

A method and system for providing targeted advertising to consumers is disclosed. Identifying information for a consumer is received. A credit attribute for the consumer using the identifying information is retrieved. At least one advertisement is stored in which each advertisement includes a corresponding credit attribute range. An advertisement for presentation to the consumer is selected based on the credit attribute of the consumer and the credit attribute range of the advertisement.

### FIELD OF THE INVENTION

The present invention relates to web site advertising and more specifically to targeted advertising based on credit attributes including credit scores.

### BACKGROUND OF THE INVENTION

Vendors and retailers have been using targeted advertising techniques almost since the inception of the free market. Targeted advertising involves the selection of a demographic or other group of people to which to advertise, and the creation and placement of advertisements directed toward this group. Currently, advertisers use a variety of information to target their advertisements, including, for example, age, income level, region, education level and race. This information, for example, helps a luxury car manufacturer market its product to high net worth individuals with a high education level while also helping a game console maker market its product to young males.

The information used to target advertisements to individuals is available from a variety of sources. A number of information clearinghouses compile information about consumers and sell it to retailers who, in turn, use it to concentrate their marketing efforts on those individuals most likely to take advantage of their product or service. One problem with this approach, however, is the inability to purchase one of the most telling pieces of information about a consumer—his/her credit score. A credit score is a numerical expression based on a statistical analysis of a person's credit files representing the creditworthiness of that person. Creditworthiness corresponds to the likelihood that the person will pay his or her debts. Credit attributes are also highly correlated to other behaviors such as the likelihood to get into a car accident. A credit score is primarily based on credit report information. Credit score is one of a group of credit attributes such as available credit, open mortgage balances, etc.

Credit bureaus, or credit reporting agencies, used interchangeably herein, refer to companies that compile and provide credit information on individuals. There are currently three main credit reporting agencies in the U.S. Credit reporting agencies are for-profit corporations that collect, organize, and store a consumer's current and past debt payment history and other financial information such as collections, judgments, tax liens, bankruptcies, etc. Credit reporting agencies are regulated by the federal government and there are restrictions on how this credit information is exchanged. In general, only a consumer himself is allowed to obtain his credit information, including his credit score, unless he gives permission to a third party to obtain the information on this behalf. One exception to this rule is provided to financial services companies, such as credit card providers, who are allowed to obtain a consumer's credit information without his permission. Financial services companies use this information to provide offers of credit to consumers.

Because non-financial service companies, e.g., retailers, are not allowed to purchase credit score information from the credit reporting agencies, the precision of their targeted advertisements is limited. Although retailers can target their advertisements based on other attributes, they cannot target based on credit attributes such as credit score, which indicates the ability of a consumer to pay. As such, retailers that sell products or services that require payment over time, such as insurance providers or providers of auto loans, cannot offer preferential pricing or discounts in their advertisements to consumers with good credit.

Thus, there is a need to overcome the problems with the prior art, and more particularly for a more efficient way to provide targeted advertising to consumers based at least in part on credit score.

### SUMMARY OF THE INVENTION

The present invention advantageously provides a method, system and computer program product for providing targeted advertising to consumers based on a variety of attributes including credit score.

In accordance with one aspect, the present invention provides a method for providing targeted advertising to consumers in which identifying information for a consumer is received. A credit attribute for the consumer using the identifying information is retrieved. At least one advertisement is stored in which each advertisement includes a corresponding credit attribute range. An advertisement for presentation to the consumer is selected based on the credit attribute of the consumer and the credit attribute range of the advertisement.

In accordance with another aspect, the present invention provides a computer program product having a computer usable medium including a computer readable program for targeted advertising which when executed on a computer causes the computer to receive identifying information for a consumer, retrieve a credit attribute for the consumer using the identifying information, store at least one advertisement, each advertisement including a corresponding credit attribute range and select an advertisement for presentation to the consumer based on the credit attribute of the consumer and the credit attribute range of the advertisement.

In accordance with still another aspect, the present invention provides a system for providing targeted advertising to consumers in which there is an advertisement data database storing at least one advertisement and a consumer data database. Each advertisement includes a corresponding credit attribute range. An advertising management computer is in communication with the advertisement data database and the consumer data database. The advertising management computer includes a processor that operates to receive identifying information for a consumer and store the identifying information in the consumer data database, retrieve a credit attribute for the consumer using the identifying information and store the credit attribute for the consumer in the consumer data database, and select an advertisement from the advertisement data database for presentation to the consumer based on the credit attribute of the consumer and the credit attribute range of the advertisement.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is an illustration of a block diagram showing an exemplary system constructed in accordance with the principles of the present invention;

FIG. 2 is a flowchart showing a general control flow of the advertisement management process in accordance with the principles of the present invention;

FIG. 3 is a flowchart showing an exemplary control flow of the advertisement management process from the perspective of a vendor;

FIG. 4 is a flowchart showing the control flow of the advertisement management process from the perspective of the advertisement management server; and

FIG. 5 is an illustration of an exemplary screen display constructed in accordance with the principles of the present invention that is displayed to a first time visitor;

FIG. 6 is an illustration of an exemplary screen display constructed in accordance with the principles of the present invention of a web page used to allow a consumer to register;

FIG. 7 is an illustration of an exemplary screen display constructed in accordance with the principles of the present invention of a web page displaying the consumer's credit score(s);

FIG. 8 is an illustration of an exemplary screen display constructed in accordance with the principles of the present invention of a web page used to allow a consumer to see targeted offers;

FIG. 9 is an illustration of an exemplary screen display constructed in accordance with the principles of the present invention of a web page used to greet a consumer upon return to the web site;

FIG. 10 is an illustration of an exemplary screen display constructed in accordance with the principles of the present invention of a web page used to allow a consumer to retrieve his/her credit score a subsequent time;

FIG. 11 are illustrations of web pages used during the advertisement management process to exchange information in accordance with the principles of the present invention; and

FIG. 12 is a block diagram of an exemplary computer for implementing an embodiment of the present invention.

### DETAILED DESCRIPTION OF THE INVENTION

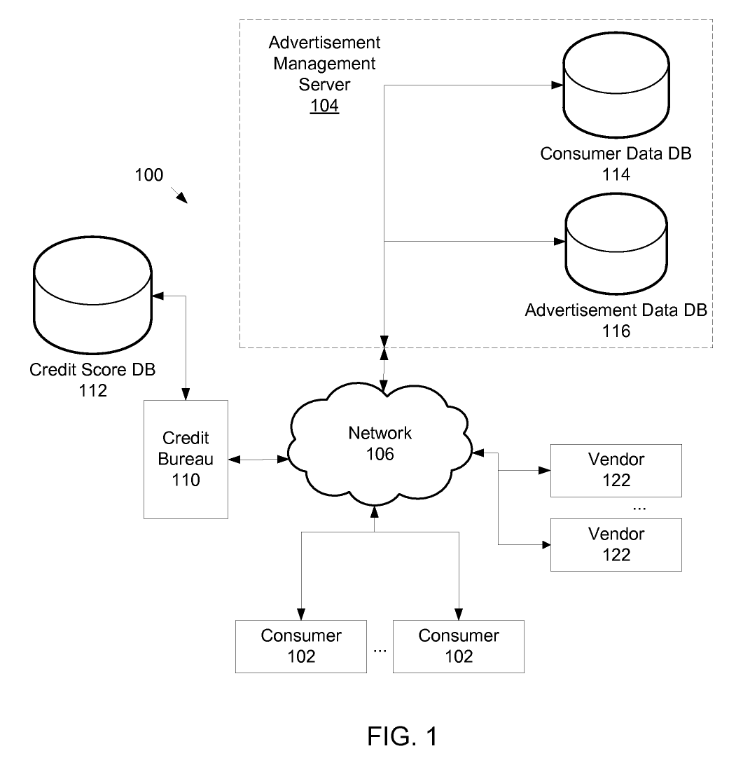

As an initial matter, it is noted that the terms “advertisement” and “offers” are used interchangeably herein. Referring now to the drawing figures in which like reference designators refer to like elements, there is shown in FIG. 1 an example of an advertising management system constructed in accordance with the principles of the present invention and designated generally as “100”. System 100 includes one or more consumer computers 102 and vendor computing workstations 122 interacting with an advertisement management server 104 over a network 106. As an example, network 106 can be the Internet and system 100 can be arranged to service multiple users in more than one location and for multiple tasks.

FIG. 1 shows consumer computers 102 and vendor computers 122 connected to a network 106. It is noted that, although FIG. 1 shows only two consumer computers 102 and two vendor computers 122, the system of the present invention supports any number of consumers and vendors. System 100 also includes an advertisement management server 104 connected to the network 106. The advertisement management server 104 and its functions are described in more detail with reference to the figures below.

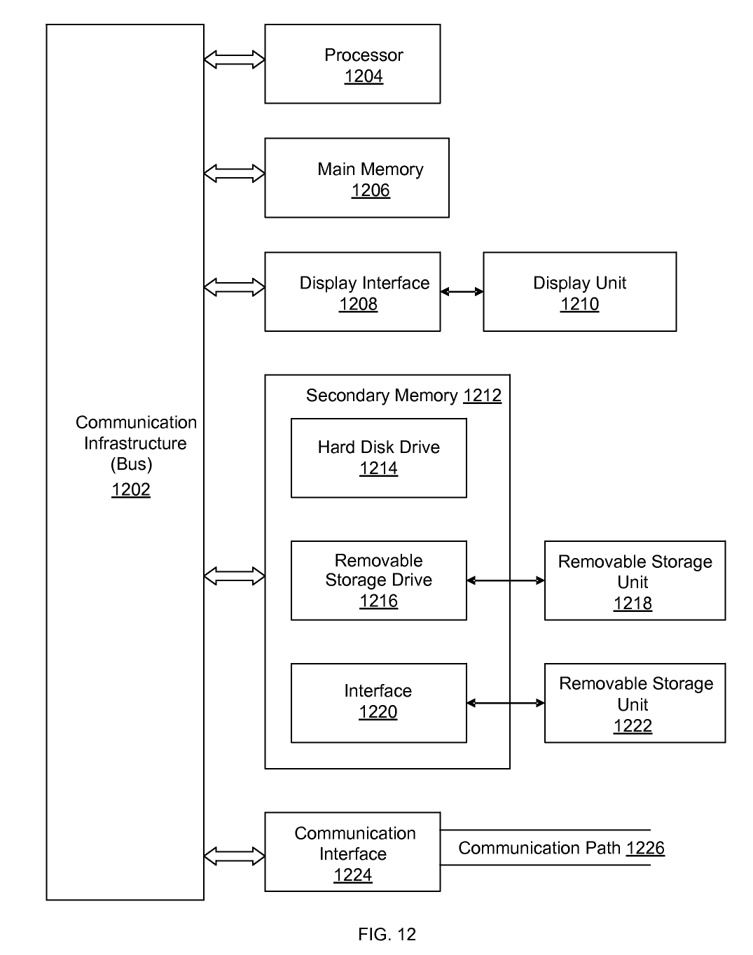

In an embodiment of the present invention, the computer systems of client computers 102, 122 and server 104 are one or more Personal Computers (PCs), Personal Digital Assistants (PDAs), hand held computers, palm top computers, lap top computers, smart phones, game consoles or any other information processing devices. A PC can be one or more IBM or compatible PC workstations running a Microsoft Windows or LINUX operating system, one or more Macintosh computers running a Mac OS operating system, or an equivalent. In another embodiment, the client computers 102-103, 122-123 and server 104 are a server system, such as SUN Ultra workstations running a SunOS operating system or IBM RS/6000 workstations and servers running the AIX operating system. Computers 102, 122 and server 104 are described in greater detail below with reference to FIG. 12.

In an embodiment of the present invention, the network 106 is a circuit switched network, such as the Public Service Telephone Network (PSTN). In another embodiment, the network 104 is a packet switched network. By way of non-limiting example, the packet switched embodiment can be a wide area network (WAN), such as the global Internet, a private WAN, or virtual private network (VPN), a local area network (LAN), a telecommunications network or any combination of the above-mentioned networks. In yet another embodiment, the structure of the network 106 is a wired network, a wireless network, a broadcast network or a point-to-point network.

In an embodiment of the present invention, the advertisement management server 104 is an application server, which is a software engine that delivers applications to client computers. The advertisement management server 104 handles most, if not all, of the business logic and data access of the advertisement management functions of the present invention. The advertisement management server 104 may adhere to any available server platform, such as the Sun Microsystems J2EE platform, a Web-based application platform, an integrated platform for e-commerce or a content management system platform.

FIG. 1 further shows several components of advertisement management server 104 connected to the network 106. The advertisement management server 104 includes a consumer data database 114 and an advertisement data database 116. The consumer data database 114 is a repository for consumer data used by advertisement management server 104 during the course of operation. The consumer data database 114 includes information pertaining to each consumer to the advertisement management server 104 to perform the functions described herein. Such consumer information includes one or more of the consumer's name, address, date of birth, age, social security number, etc. The consumer data database 114 also includes consumer information that may be modified by the advertisement management server 104 during the course of operation, such as a consumer's credit attributes, including credit score, surfing history, etc. The data gathered by the advertisement management server 104 for each consumer is described in greater detail below.

The consumer data database 114 may adhere to any one of the flat model, hierarchical model, object-oriented model or a relational model for databases. Further, the consumer data database 114 can be any commercially available database, such as an Oracle Database, Enterprise or Personal Edition, available from Oracle Corporation, or a Microsoft SQL Server or Access 2000 database available from Microsoft Corporation. Database 114 is not limited to commercially available databases. It is also contemplated that database 114 can be an open source database.

The consumer data database 114 may also include a database management system, which is an application that controls the organization, storage and retrieval of data (fields, records and files) in database 114. The database management system accepts requests for data from the advertisement management server 104 and instructs the operating system to transfer the appropriate data. The database management system may also control the security and integrity of the database 114. Data security prevents unauthorized users from viewing or updating certain portions of the consumer database 114. The database management system can be any commercially database management system, such as the Oracle E-Business Suite available from Oracle Corporation, or an open source database management system. The consumer database 114 may be integrated with the server 104 or may be a separate device in communication with the server 104.

FIG. 1 further shows that the advertisement management server 104 includes an advertisement data database 116. The advertisement data database 116, similar to the consumer database 114, is a repository for advertisement data used by the advertisement management server 104 during the course of operation. The advertisement data database 116 includes information pertaining to each advertisement necessary for performing the functions of the advertisement management server 104 Such advertiser information includes one or more of the graphics of an advertisement, the text of an advertisement, the dates of validity of an advertisement, the conditions of an advertisement, etc. The advertisement data database 116 also includes advertisement information that may be modified by the advertisement management server 104 during the course of operation, such as the click-through rate of an advertisement, the view time of an advertisement, etc. The data gathered by the advertisement management server 104 for each advertisement is described in greater detail below.

The advertisement data database 116 may adhere to any one of the models of the consumer data database 114 and may also include a database management system. The advertisement database 116 may be integrated with the server 104 or may be a separate device in communication with the server 104.

Advertisement management server 104 connects directly to the network 106 via a network interface, such as a network interface card. Alternatively, the advertisement management server 104 includes a Web server that connects to the network 106 via a network interface. In this alternative, the advertisement management server 104 is logically connected to the Web server, which provides a Web interface available to client computers (such as consumer computers 102 and vendors 122) of the advertisement management server 104. This option is advantageous as a Web interface allows any clients having a Web browser to connect to the advertisement management server 104. A Web interface provides a simple, efficient, highly compatible, economical and highly available connection to the advertisement management server 104 to a wide range of client computers.

FIG. 1 also shows a credit bureau 110, which represents a credit reporting agency, or a company that provides credit information on individuals. There are currently three main credit reporting agencies in the U.S. Credit reporting agencies are for-profit corporations that collect, organize, and store a consumer's current and past debt payment history and other financial information such as collections, judgments, tax liens, bankruptcies, etc. Credit bureau 110 stores and maintains credit information and scores in a credit attribute database 112. Note that although FIG. 1 shows only one credit bureau 110 and one credit attribute database 112, the present invention supports any number of credit bureaus 110 and credit attribute databases 112.

FIG. 1 shows a group of clients (such as consumer computers 102 and vendor computers 122) in data communication with the advertisement management server 104. These clients may execute client applications, such as compiled or interpreted executable modules written in C++, Java, Visual Basic, HTML, XML, Flash or separate Java applets, Java scriptlets, Java scripts, Perl scripts, Active X controls or any self-sufficient application executing on a client computer. The clients of FIG. 1, i.e., consumer computers 102 and vendor computers 122, can communicate with the advertisement management server 104 via a Web interface such as a commercially available or open source Web browser, e.g., Netscape Navigator and Microsoft Internet Explorer.

It should be noted that in the embodiment of the present invention described above, the clients, i.e., consumer computers 102 and vendor computers 122, are depicted as separate from the advertisement management server 104. In this embodiment, the clients communicate with the computer system of the advertisement management server 104 over a network 106 or other communication medium. In an alternative embodiment of the present invention, any one or all of the clients can be integrated with the computer system of the advertisement management server 104. In this alternative embodiment, those modules or clients that are integrated with the advertisement management server 104 share the same computing resources as the advertisement management server 104.

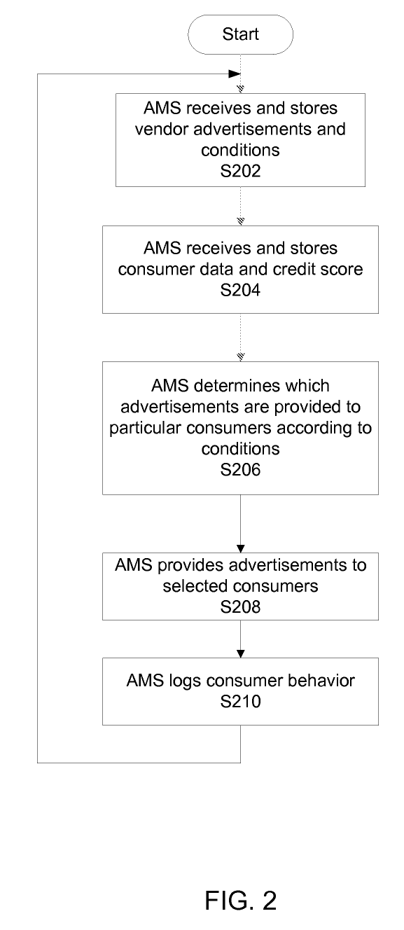

FIG. 2 is a flowchart of an exemplary general control flow of the advertisement management process in accordance with the principles of the present invention. FIG. 2 shows the general process undertaken by the advertisement management server 104 as it interacts with the consumer computer 102, vendor computer 122 and credit bureau 110 during the advertisement management process. It should be noted that although the control flow of FIG. 2 shows a sequential process, this arrangement is not limited to such and the sequence of steps S202-S210 may occur in alternative combinations. The control flow of FIG. 2 begins with step S202.

At step S202, the advertisement management server 104 interacts with one or more vendor computers 122 so as to gather advertisement data. Advertisement data includes information pertaining to advertisements that each vendor desires to provide to consumer computers 102 via the advertisement management server 104.

At step S204, the advertisement management server 104 interacts with one or more consumer computers 102 via client computers so as to gather consumer data. The advertisement management server 104 may garner identifying information for each consumer and store this data in the consumer data database 114. In step 204, the advertisement management server 104 may garner additional consumer information, such as credit attribute, by interacting with a third party, such as a credit bureau 110. The gathering of the credit attribute from the credit bureau 110 is initiated by the consumer via consumer computer 102. In other words, the consumer affirmatively “opts-in” and authorizes credit bureau 110 to release his/her credit attributes to the provider of advertising management server 104 for storage and inclusion in the consumer data database 114.

At step S206, the advertisement management server 104 determines which advertisements are provided to particular consumers according to the conditions specified by the vendor for each advertisement. Depending on whether the consumer has opted in and allowed his/her credit attributes to be obtained from credit bureau 110, the conditions can include consumer credit attributes such as credit score. As such, the advertisement management server 104 determines which advertisements are provided to each consumer. As discussed below, advertisements can take the form of banner advertisements and/or larger web-page based offers.

In one embodiment of the present invention, the advertisement management server 104 performs this operation by initiating a determination process when a consumer visits or logs onto a Web site of the advertisement management server 104. First, an object in the consumer data database 114 corresponding to the consumer is retrieved. Next, the advertisement management server 104 evaluates the criteria corresponding to the advertisements in the advertisement data database 116 and determines whether the conditions of each advertisement are met by the attributes of the current consumer object. If the conditions of an advertisement are met by the attributes of the current consumer object, then the advertisement management server 104 selects the advertisement for provision to the consumer. For example, if an advertisement contains a condition that it shall be provided to consumers in their 40s with a credit score between 700 and 750, then the advertisement shall be provided to consumer A, who is age 45 with a credit score of 740, but it shall not be provided to consumer B, who is age 29 with a credit score of 680.

In one embodiment of the present invention, the advertisement management server 104 may select a predetermined number of non-qualified consumers to which to provide certain advertisements. For example, if an advertisement contains a condition that it shall be provided to consumers in their 40s with a credit score between 700 and 750, then the advertisement management server 104 may select a predetermined number of consumers with a credit score less than 700 to which to provide the advertisement. This is done, for example, to facilitate anonymity in the case where only one consumer would otherwise meet the credit score-based criteria.

At step S208, the advertisement management server 104 provides the selected advertisements to each consumer for which the advertisements were selected. In an embodiment of the present invention, the advertisement management server 104 provides the selected advertisements to a consumer via a web page. For example, the advertisement management server 104 may execute or interpret the source of a selected advertisement in a Web page provided to the consumer or simply display the text of the advertisement in the Web page.

At step S210, the advertisement management server 104 logs consumer behavior. As consumers visit a web site of the advertisement management server 104, the server 104 logs certain consumer behavior such as the identity of the advertisements on which the consumer has clicked through and the amount of time the consumer spent reading each advertisement. The advertisement management server 104 may log each element of this behavior as an attribute in the object representing a consumer in the consumer data database 114. Additionally, the advertisement management server 104 may log each element of this behavior as an attribute in the object representing an advertisement in the advertisement data database 116. For example, for each advertisement, the advertisement management server 104 may store as an attribute the click-through rate of the advertisement, and the average view time of the advertisement.

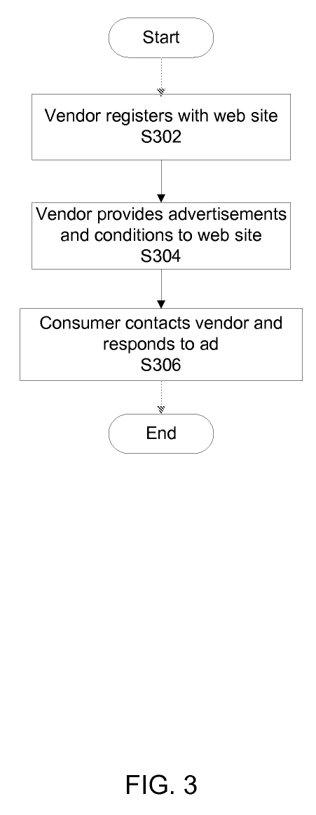

FIG. 3 is a flowchart of an advertisement management process from the perspective of a vendor in accordance with the principles of the present invention. FIG. 3 provides more detail regarding the interaction between the advertisement management server 104 and the vendor computers 122.

At step S302, a vendor via vendor computer 122, registers with a web site of the advertisement management server 104. It is also contemplated that any such vendor program registration or participation can be configured by the provider of the management server 104 without the need for the vendor to use a vendor computer 122. In an embodiment of the present invention, either of the above acts can serve to instantiate an instance of an object representing the vendor in the advertisement data database 116. In step S304, the vendor interacts with the server 104 so as to provide advertisement data.

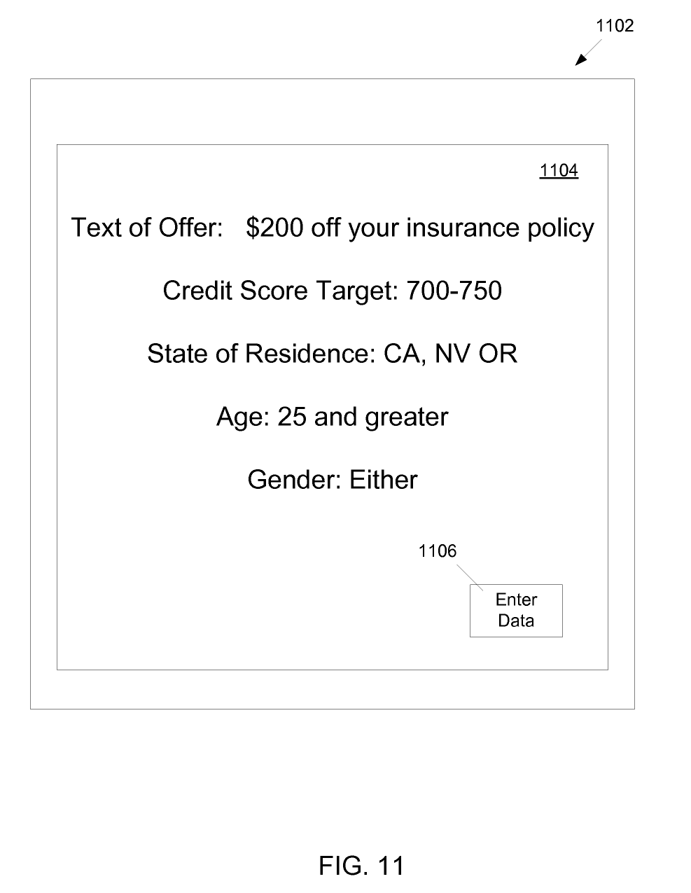

Advertisement data includes information pertaining to advertisements that the vendor desires to provide to consumer computers 102 via the advertisement management server 104. The advertisement management server 104 may garner advertisement data from the vendor, such as the source code of an advertisement, the graphics of an advertisement, the text of an advertisement, the dates of validity of an advertisement, the conditions of an advertisement, etc. in a variety of ways. For example, the advertisement management server 104 may garner advertisement data via a web page presented to the vendor via his client computer. Such a web page is described in greater detail below with reference to FIG. 11. Subsequent to gathering the advertisement data, the advertisement management server 104 stores this data in the advertisement data database 116, such as in an object representing the vendor.

In an embodiment of the present invention, an advertisement may take a variety of forms. In one example, an advertisement may simply be text that is provided via a Web page. The text may provide an offer to a consumer, such as an offer for a car loan of up to $20,000 for 48 months at a 2.9% APR. The text may provide a rebate, preferential pricing or a discount to a consumer. In another example, an advertisement may include text and graphics that convey an offer via a Web page. In another example, an advertisement may include text, graphics, audio and/or video that is provided via a Web page. In another example, an advertisement could include links to other sites, prompts to call a specific phone numbers, directives to fill out specific form or application.

In yet another embodiment of the present invention, an advertisement may be any one of a variety of web ads, including but not limited to a banner ad, a sidebar ad, a pop-up ad, a floating ad or simply a link to another web page containing the offer. Banner ads are rectangular advertisements which generally appear horizontally at the top or bottom of a web page. Some banner ads are static while others use graphics, video and audio. Other banner ads automatically fill a web page when first opened and then shrinks back to normal size after a period of time. Sidebar ads are similar to banner ads except they are positioned vertically down the side of a web page. Pop-up ads automatically appear in their own, small web browser window. Floating ads appear when a web page is first opened, floating over the page for a predetermined period of time. Floating ads often cannot be closed.

For any of the types of advertisements above, the advertisement may comprise source code or a computer readable medium that includes instructions for executing the advertisement. For example, an advertisement may comprise JavaScript, which is a scripting language embedded in HTML code for a Web page, wherein upon execution, the scripting language can produce a visual effect.

In an embodiment of the present invention, the conditions of an advertisement comprise consumer attributes that identify a target for the advertisement. For example, a condition of an advertisement may specify that the advertisement is a targeted towards males of age 25-35 with an annual income greater than $100,000 and a credit score between 700 and 750.

In another embodiment of the present invention, the advertisement management server 104 stores the advertisement data for each advertisement in a child object stored in the advertisement data database 116, wherein the object is a child of the object representing the vendor. Each piece of advertisement data, including the source code of an advertisement, the graphics of an advertisement, the text of an advertisement, etc. is stored in the child object as an attribute.

Optionally, in step S304, the vendor makes arrangements to provide payment to the advertisement management server 104 for its services providing vendor advertisements to consumers. In one embodiment, payment is provided online via an online merchant account wherein payment is determined by any one or more of the following factors: the number of click-throughs experienced by the vendor for each advertisement, the amount of time each advertisement is provided by the server 104, the amount of time each advertisement of the vendor is viewed and the number of registrations or sales.

In step S306, one or more consumers respond to an advertisement of the vendor by contacting the vendor to take advantage of the advertisement. As explained above, an advertisement may include HTML code that includes a link that re-routes a consumer to a web site of the vendor. In this scenario, the vendor may provide its offer of goods or services to the consumer.

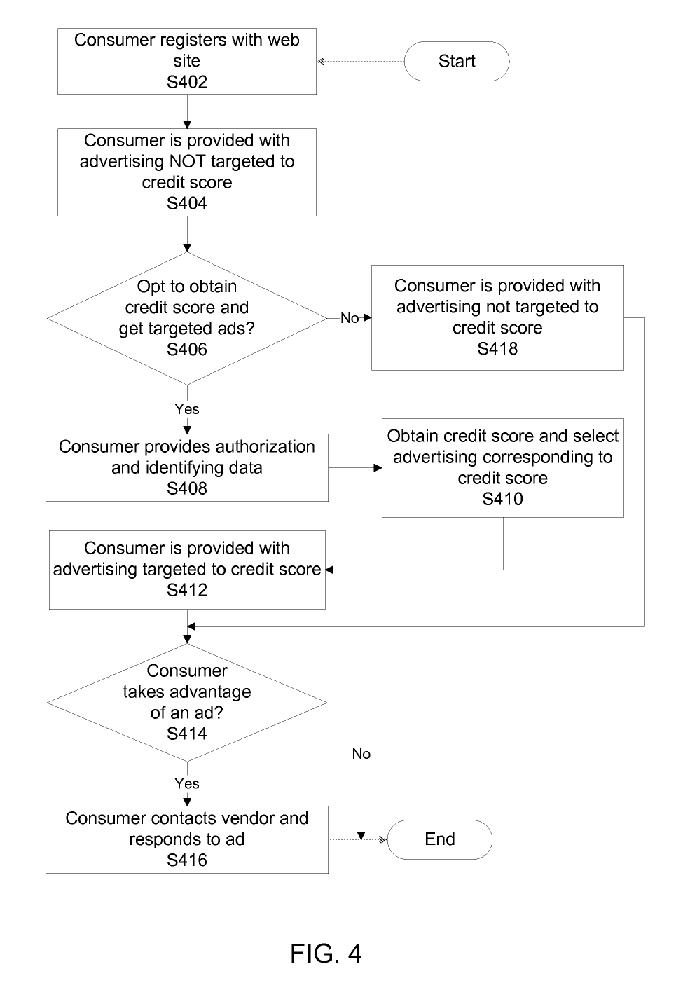

FIG. 4 is a flowchart of an advertisement management process from the perspective of the advertisement management server 104 in accordance with the principles of the present invention. FIG. 4 details the interaction between the advertisement management server 104 and the consumer computers 102.

At step S402, a consumer via consumer computer 102, registers with a web site of the advertisement management server 104. In an embodiment of the present invention, this act instantiates an instance of an object representing the consumer in the consumer data database 114. At step S402, the consumer may provide consumer data such as the consumer data described below. As discussed below, the consumer need not register before being presented with non-targeted ads and other content.

At step S404, the consumer is optionally provided with advertisements that are not targeted to credit attribute. In this step, the advertisement management server 104 provides advertisements to the consumer, wherein the advertisements can be either random or selected based on certain attributes, such as age, gender, and income level. In an embodiment of the present invention, the advertisement management server 104 provides the selected advertisements to the consumer via a web page. For example, the advertisement management server 104 may execute or interpret the source of a selected advertisement in a web page provided to the consumer or simply display the text of the advertisement in the web page.

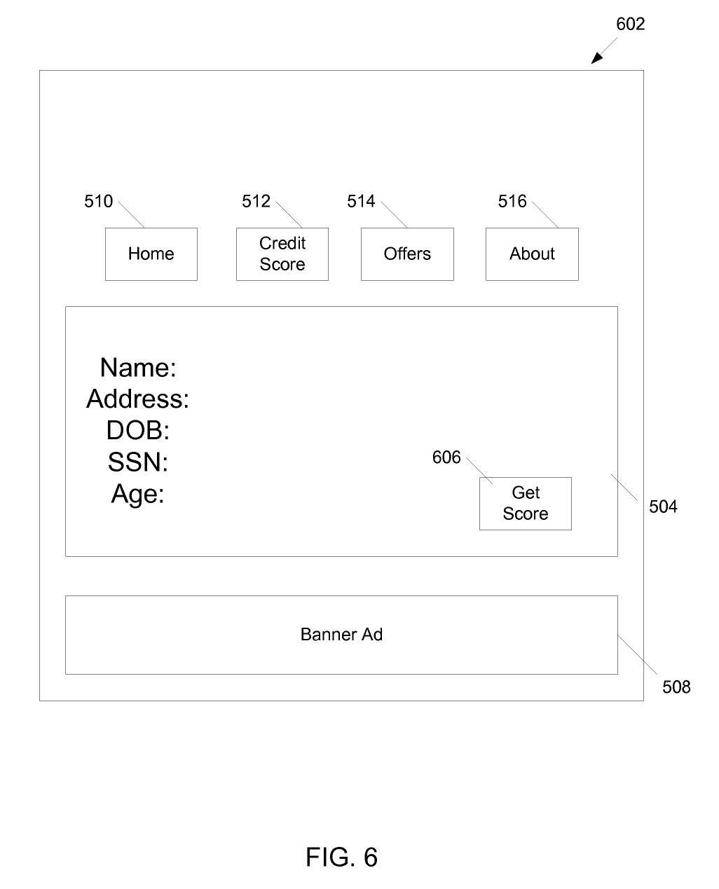

At step S406, the consumer is provided with a choice as to whether to opt to obtain his/her credit score (or other credit attributes) free of charge so as to receive advertisements targeted to his/her credit attributes. In one embodiment, the consumer may effectuate this choice by clicking a button or other widget on a web page. At step S408, the consumer interacts with the server 104 so as to provide consumer authorization and identification data to allow the advertisement management server (or some other computing device under the control of the service provider) to obtain the consumer's credit attributes from one or more credit bureaus 100 (step S410). The advertisement management server 104 may garner identifying information for each consumer (not already garnered in step S402 above), such as a consumer's name, address, date of birth, age, gender, income, occupation, education level, social security number, etc. in a variety of ways. For example, the advertisement management server 104 may garner identifying information via a web page presented to the consumer via his client computer. Such a web page is described in greater detail below with reference to FIG. 6. Subsequent to gathering the consumer data, the advertisement management server 104 stores this data in the consumer data database 114.

In step S410, the advertisement management server 104 garners additional consumer information, such as credit attributes, by interacting with a third party, such as a credit bureau 110. The advertisement management server 104 may obtain this information by sending, via an Internet communications module, a request to the credit bureau 110, wherein the request includes the identifying and authorization data for a consumer. The credit bureau 110 may then send a response to the advertisement management server 104, wherein the response includes a credit attribute for the consumer. This additional consumer information is also stored in the consumer data database 114. In an embodiment of the present invention, the request and response above may be exchanged using a variety of information exchange formats, including Electronic Data Interchange (EDI), Transfer Control Protocol/Internet Protocol (TCP/IP), File Transfer Protocol (FTP), HyperText Transfer Protocol (HTTP), Simple Mail Transfer Protocol (SMTP), or an equivalent.

In an embodiment of the present invention, the advertisement management server 104 stores the consumer data for each consumer in an object stored in the consumer data database 114. Each element of consumer data, including the consumer's name, address, date of birth, credit attribute, etc. is stored in the object as a consumer attribute.

Also in step S410, the advertisement management server 104 determines which advertisements from advertisement data database 116 are provided to the consumer. This step is described in more detail with reference to step S206 of FIG. 2 above.

In step S412, the consumer is provided with advertisements that are targeted to credit attributes. In this step, the advertisement management server 104 provides advertisements to the consumer, wherein the advertisements are selected based on one or more consumer attributes in which credit score (or some other credit-related attribute) is a consumer attribute. In an embodiment of the present invention, the advertisement management server 104 provides the selected advertisements to the consumer via a web page. For example, the advertisement management server 104 may execute or interpret the source of a selected advertisement in a web page provided to the consumer or simply display the text of the advertisement in the web page.

In step S414, a consumer determines whether to respond to an advertisement. If the consumer responds to the advertisement (such as by clicking on a button or selecting a link on a web page), then step S416 is executed. Otherwise, the process ends or the consumer may view other ads and content within the web site (not shown).

In step S416, the consumer responds to an advertisement of the vendor by contacting the vendor to take advantage of the advertisement. As explained above, an advertisement may include HTML code that includes a link that re-routes a consumer to a web site of the sponsoring vendor. In this scenario, the vendor may provide its offer of goods or services to the consumer. In the case of an ad targeted to the consumer based on credit attributes, it is contemplated that the offer by the vendor will provide preferential pricing or some other preferential incentive to consumers having credit attributes in a particular range, such as credit scores above a predetermined level. It is also contemplated that the pricing of offers can be banded such that different ranges of credit attributes, such as credit scores, result in different offer prices.

It is noted that the present invention advantageously provides an environment in which credit attribute information is not provided to the vendors. This allows consumers to maintain anonymity with respect to the vendors but still benefit from their good credit scores.

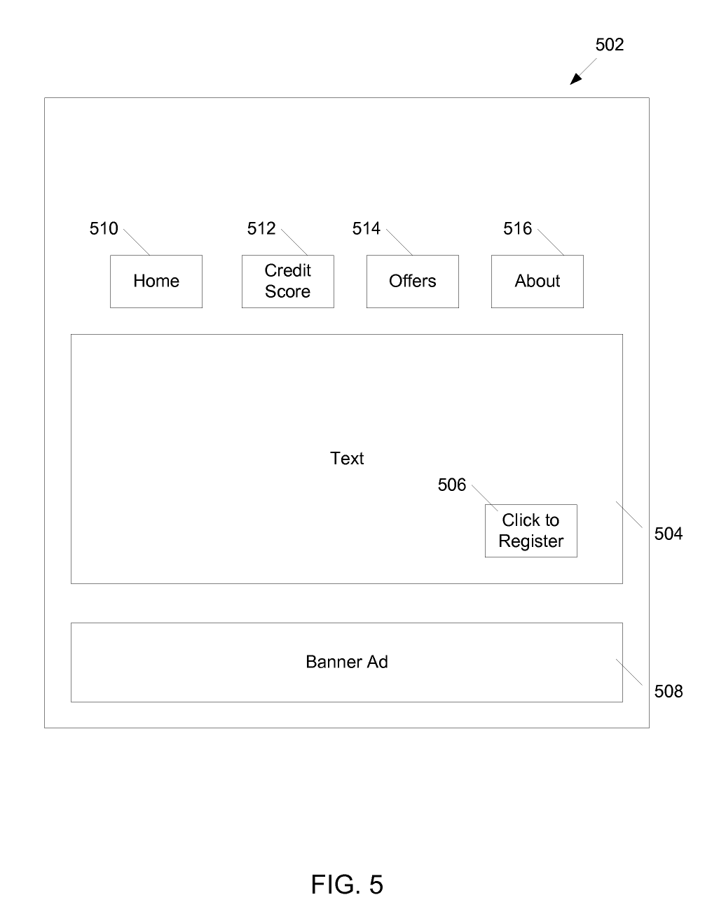

Exemplary display screen arrangements constructed in accordance with the principles of the present invention are described. It is understood however, that the present invention is not limited to the screen arrangements described herein. FIG. 5 is an illustration of a web page 502 used to greet a first time visitor to the web site of the advertisement management server 104. Exemplary web page 502 includes a text area 504, such as a text field, four buttons 510, 512, 514 and 516 and a banner ad 508. In an embodiment of the present invention, text field 504 includes welcome text and the banner ad 508 includes a non-targeted advertisement since no information is known about the current visitor. Web page 502 also includes a “Register” button 506 used to bring the user to another Web page that allows the user to register with the advertisement management server 104.

The button 510, entitled “Home,” is used to bring the user back to the home page while the button 512, entitled “Credit Score,” is used to bring the user to another Web page used to obtain the user's credit score free of charge. The button 514, entitled “Offers,” is used to bring the user to a Web page containing targeted offers while the button 516, entitled “About,” is used to bring the user to another Web page including information about the company hosting the Web site.

FIG. 6 is an illustration of a web page 602 used to allow a consumer to register with the web site of the advertisement management server 104. FIG. 6 corresponds to step S408 of FIG. 4. Web page 602 can include one or more of the same components as web page 502, except that text field 504 includes multiple fields into which the consumer enters identifying information such as name, address, etc. Web page 602 also includes a “Get Score” button 606 used to bring the user to another web page that allows the user to see his credit score (and/or other credit attributes) obtained by the advertisement management server 104 via step S410.

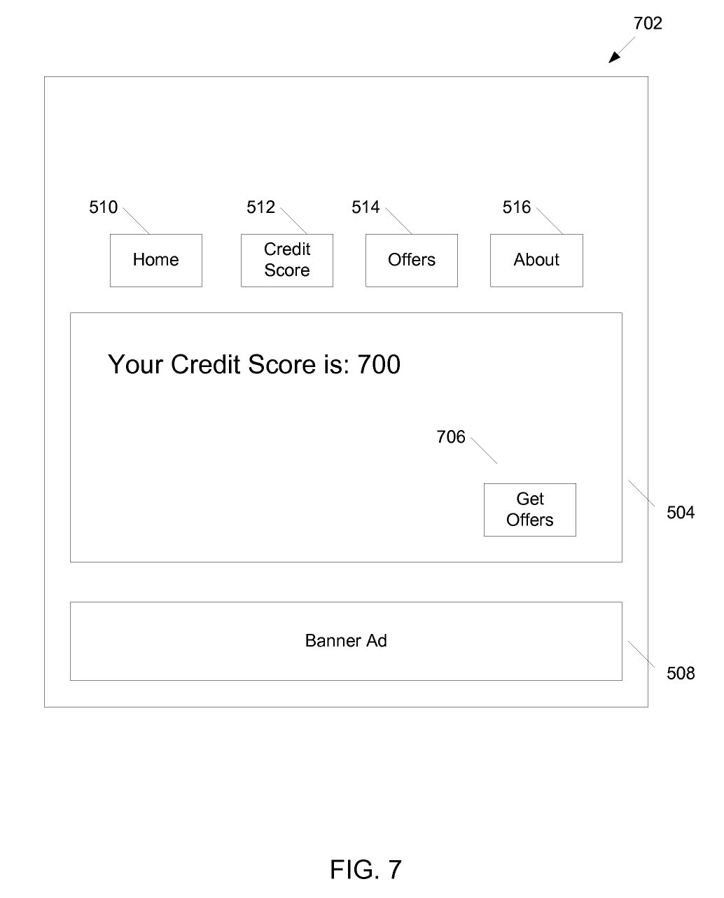

FIG. 7 is an illustration of a web page 702 used to allow a consumer to see his/her credit score (and/or other credit attributes) obtained by advertisement management server 104. Web page 702 can include one or more of the same components as web page 502, except that text field 504 includes the consumer's credit score(s). Web page 702 also includes a “Get Offers” button 706 used to bring the user to another Web page that allows the user to see targeted offers provided to him by the advertisement management server 104 via processes 206, 208. The banner ad 508 includes a targeted advertisement since credit attribute information is known about the consumer.

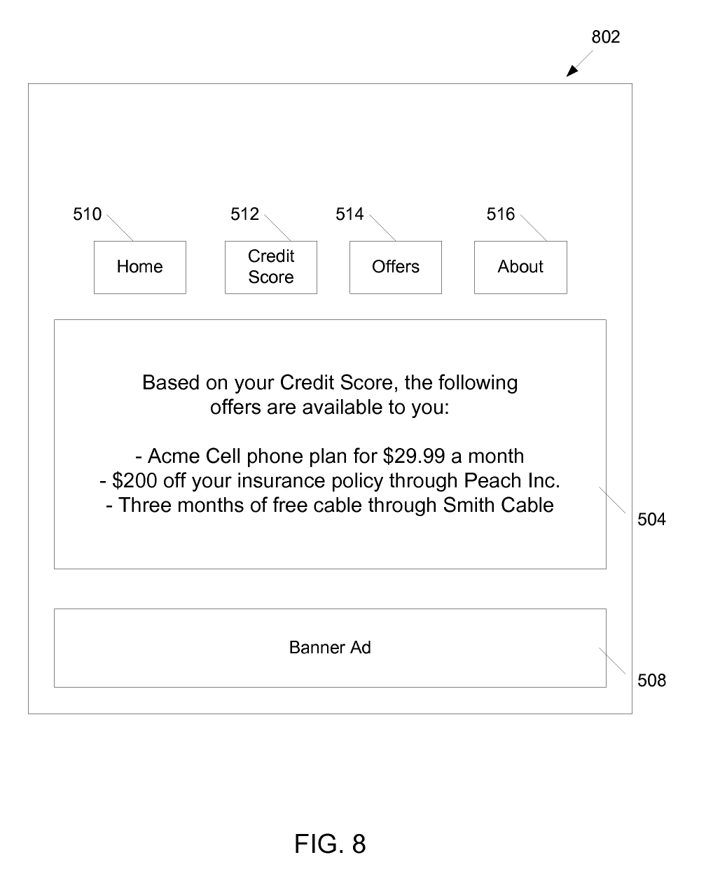

FIG. 8 is an illustration of a web page 802 used to allow a consumer to see targeted offers provided to him/her by the advertisement management server 104. FIG. 8 corresponds to step 208 of FIG. 2. Web page 802 can include one or more of the same elements as web page 502, except that text field 504 includes the targeted offers provided to the consumer by the advertisement management server 104. The banner ad 508 includes a targeted advertisement since credit attribute information is known about the consumer.

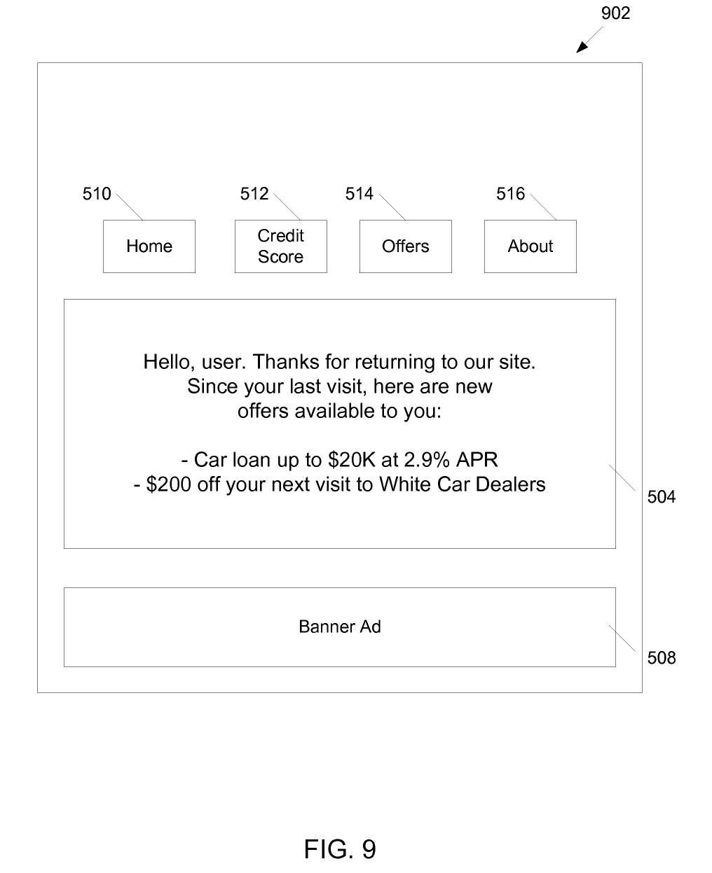

FIG. 9 is an illustration of a web page 902 used to greet a consumer upon return to the web site of the advertisement management server 104. FIG. 9 corresponds to step 208 of FIG. 2. Web page 902 can include one or more of the same elements as web page 502, except that text field 504 includes the offers provided to the consumer by the advertisement management server 104. The banner ad 508 includes a targeted advertisement since credit attribute information is known about the consumer.

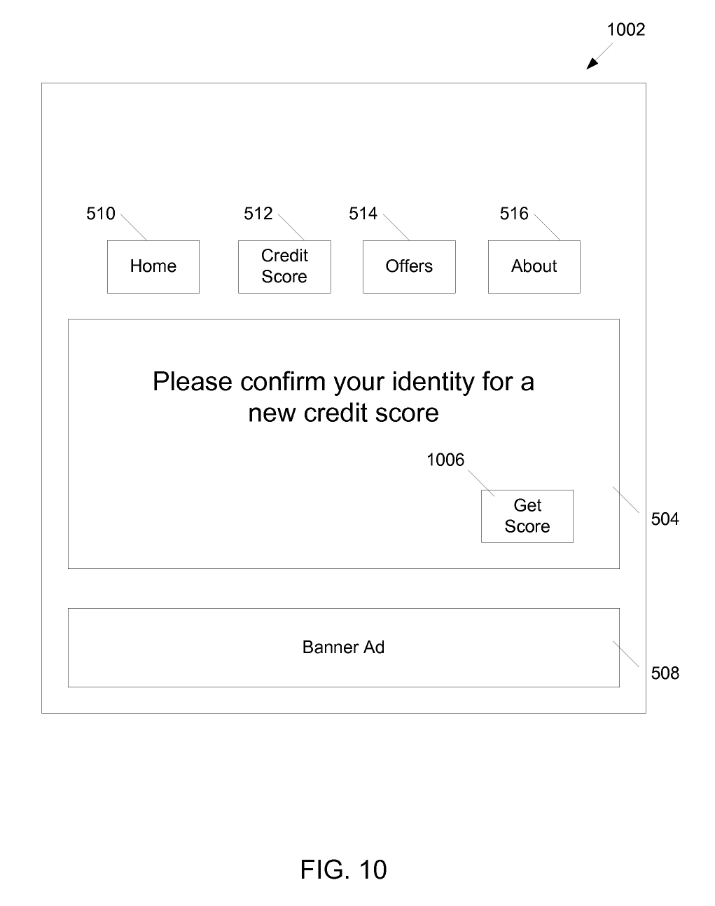

FIG. 10 is an illustration of a web page 1002 used to allow a consumer to retrieve his/her credit attributes, such as credit score, a subsequent time from the web site of the advertisement management server 104. Web page 1002 can include one or more of the same elements as web page 502, except that text field 504 includes text that indicates to the consumer that he should press the button 1006 if his identifying information is accurate. Web page 1002 also includes a “Get Score” button 1006 used to bring the user to another web page that allows the user to see his re-generated credit score obtained by the advertisement management server 104 via process S410.

FIG. 11 is an illustration of a web page 1102 used to allow a vendor to enter an advertisement and its attributes via the web site of the advertisement management server 104. FIG. 11 corresponds to step S304 of FIG. 3. Web page 1102 includes a text field 1104 that itself can include multiple fields into which the vendor enters advertisement information such as the offer of the text, the credit attribute target, etc. Web page 1102 also includes an “Enter Data” button 1106 used to enter the data typed into field 1104 into the advertisement management server 104 for storage in advertisement data database 116.

The present invention can be realized in hardware, software, or a combination of hardware and software in the system described in FIG. 1. A system according to a preferred embodiment of the present invention can be realized in a centralized fashion in one computer system, or in a distributed fashion where different elements are spread across several interconnected computer systems. Any kind of computer system, or other apparatus adapted for carrying out the methods described herein, is suited for implementing the present invention. A typical combination of hardware and software could be a general-purpose computer system with a computer program that, when being loaded and executed, controls the computer system such that it carries out the methods described herein.

An embodiment of the present invention can also be embedded in a computer program product, which comprises all the features enabling the implementation of the methods described herein, and which—when loaded in a computer system—is able to carry out these methods. Computer program means or computer program as used in the present invention indicates any expression, in any language, code or notation, of a set of instructions intended to cause a system having an information processing capability to perform a particular function either directly or after either or both of the following a) conversion to another language, code or, notation; and b) reproduction in a different material form.

A computer system may include, inter alia, one or more computers and at least a computer readable medium, allowing a computer system, to read data, instructions, messages or message packets, and other computer readable information from the computer readable medium. The computer readable medium may include non-volatile memory, such as ROM, Flash memory, Disk drive memory, CD-ROM, and other permanent storage. Additionally, a computer readable medium may include, for example, volatile storage such as RAM, buffers, cache memory, and network circuits. Furthermore, the computer readable medium may comprise computer readable information in a transitory state medium such as a network link and/or a network interface, including a wired network or a wireless network that allows a computer system to read such computer readable information.

FIG. 12 is a block diagram of a computer system useful for implementing an embodiment of the present invention. The computer system of FIG. 12 is a more detailed representation of client computers 102-103, 122-123 and server 104. The computer system of FIG. 12 includes one or more processors, such as processor 1204. The processor 1204 is connected to a communication infrastructure 1202 (e.g., a communications bus, cross-over bar, or network). Various software embodiments are described in terms of this exemplary computer system. After reading this description, it will become apparent to a person of ordinary skill in the relevant art(s) how to implement the invention using other computer systems and/or computer architectures.

The computer system can include a display interface 1208 that forwards graphics, text, and other data from the communication infrastructure 1202 (or from a frame buffer not shown) for display on the display unit 1210. The computer system also includes a main memory 1206, preferably random access memory (RAM), and may also include a secondary memory 1212. The secondary memory 1212 may include, for example, a hard disk drive 1214 and/or a removable storage drive 1216, representing a floppy disk drive, a magnetic tape drive, an optical disk drive, etc. The removable storage drive 1216 reads from and/or writes to a removable storage unit 1218 in a manner well known to those having ordinary skill in the art. Removable storage unit 1218, represents, for example, a floppy disk, magnetic tape, optical disk, etc. which is read by and written to by removable storage drive 1216. As will be appreciated, the removable storage unit 1218 includes a computer usable storage medium having stored therein computer software and/or data.

In alternative embodiments, the secondary memory 1212 may include other similar means for allowing computer programs or other instructions to be loaded into the computer system. Such means may include, for example, a removable storage unit 1222 and an interface 1220. Examples of such may include a program cartridge and cartridge interface (such as that found in video game devices), a removable memory chip (such as an EPROM, or PROM) and associated socket, and other removable storage units 1222 and interfaces 1220 which allow software and data to be transferred from the removable storage unit 1222 to the computer system.

The computer system may also include a communications interface 1224. Communications interface 1224 allows software and data to be transferred between the computer system and external devices. Examples of communications interface 1224 may include a modem, a network interface (such as an Ethernet card), a communications port, a PCMCIA slot and card, etc. Software and data transferred via communications interface 1224 are in the form of signals which may be, for example, electronic, electromagnetic, optical, or other signals capable of being received by communications interface 1224. These signals are provided to communications interface 1224 via a communications path (i.e., channel) 1226. This channel 1226 carries signals and may be implemented using wire or cable, fiber optics, a phone line, a cellular phone link, an RF link, and/or other communications channels.

In this document, the terms “computer program medium,” “computer usable medium,” and “computer readable medium” are used to generally refer to media such as main memory 1206 and secondary memory 1212, removable storage drive 1216, a hard disk installed in hard disk drive 1214, and signals. These computer program products are means for providing software to the computer system. The computer readable medium allows the computer system to read data, instructions, messages or message packets, and other computer readable information from the computer readable medium. The computer readable medium, for example, may include non-volatile memory, such as floppy, ROM, flash memory, disk drive memory, CD-ROM, and other permanent storage. It is useful, for example, for transporting information, such as data and computer instructions, between computer systems. Furthermore, the computer readable medium may comprise computer readable information in a transitory state medium such as a network link and/or a network interface, including a wired network or a wireless network that allows a computer to read such computer readable information.

Computer programs (also called computer control logic) are stored in main memory 1206 and/or secondary memory 1212. Computer programs may also be received via communications interface 1224. Such computer programs, when executed, enable the computer system to perform the features of the present invention as discussed herein. In particular, the computer programs, when executed, enable the processor 1204 to perform the features of the computer system. Accordingly, such computer programs represent controllers of the computer system.

Advantageously, the present invention provides a method, system and computer readable medium for providing targeted advertising to consumers based on a variety of consumer and credit attributes including credit score. Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A method for providing targeted advertising to consumers, comprising:
receiving identifying information for a consumer;
retrieving a credit attribute for the consumer using the identifying information;
storing at least one advertisement, each advertisement including a corresponding credit attribute range; and
selecting an advertisement for presentation to the consumer based on the credit attribute of the consumer and the credit score range of the advertisement.

2. The method of claim 1, wherein receiving identifying information for a consumer comprises:
receiving identifying information via a web site, wherein the identifying information includes a consumer's name, address, date of birth and social security number.

3. The method of claim 1, wherein retrieving a credit attribute comprises:
sending a request to a credit bureau, wherein the request includes the identifying information of a consumer; and
receiving a credit attribute for the consumer.

4. The method of claim 3, wherein storing at least one advertisement comprises:
receiving the at least one advertisement from at least one vendor, wherein the advertisement includes an offer for at least one of a good and a service, and wherein the at least one advertisement is associated with a credit attribute band.

5. The method of claim 4, wherein storing at least one advertisement further includes receiving a plurality of advertisements from at least one vendor, wherein an advertisement comprises at least one of text, graphics, audio, video and source code.

6. The method of claim 4, wherein selecting an advertisement for presentation to the consumer includes determining that the credit attribute range of an advertisement includes the credit attribute of the consumer.

7. The method of claim 6, wherein at least one advertisement is associated with additional attributes and wherein selecting an advertisement further comprises determining that the additional attributes of the advertisement are met by the consumer data corresponding to the consumer.

8. The method of claim 1, wherein an advertisement is selected for a predetermined number of consumers even though the consumers' corresponding credit attributes are not within the credit attribute range for the advertisement.

9. The method of claim 1, further comprising:
storing at least one non-targeted advertisement; and
providing the at least one non-targeted advertisement to the consumer.

10. A computer program product comprising a computer usable medium having a computer readable program for targeted advertising which when executed on a computer causes the computer to:
receive identifying information for a consumer;
retrieve a credit attribute for the consumer using the identifying information;
store at least one advertisement, each advertisement including a corresponding credit attribute range; and
select an advertisement for presentation to the consumer based on the credit attribute of the consumer and the credit attribute range of the advertisement.

11. The computer program product of claim 10, wherein retrieving a credit attribute comprises:
sending a request to a credit bureau, wherein the request includes the identifying information of a consumer; and
receiving a credit attribute for the consumer.

12. The computer program product of claim 11, wherein storing at least one advertisement comprises:
receiving the at least one advertisement from at least one vendor, wherein the advertisement includes an offer for at least one of a good and a service, and wherein the at least one advertisement is associated with a credit attribute band.

13. The computer program product of claim 12, wherein selecting an advertisement for presentation to the consumer includes determining that the credit attribute range of an advertisement includes the credit attribute of the consumer.

14. The computer program product of claim 13, wherein at least one advertisement is associated with additional attributes and wherein selecting an advertisement further comprises determining that the additional attributes of the advertisement are met by the consumer data corresponding to the consumer.

15. The computer program product of claim 10, wherein an advertisement is selected for a predetermined number of consumers even though the consumers' corresponding credit attributes are not within the credit attribute range for the advertisement.

16. A system for providing targeted advertising to consumers, the system comprising:
an advertisement data database storing at least one advertisement, each advertisement including a corresponding credit attribute range;
a consumer data database; and
an advertising management computer in communication with the advertisement data database and the consumer data database, the advertising management computer including a processor, the processor operating to:
receive identifying information for a consumer and store the identifying information in the consumer data database;
retrieve a credit attribute for the consumer using the identifying information and store the credit attribute for the consumer in the consumer data database; and
select an advertisement from the advertisement data database for presentation to the consumer based on the credit attribute of the consumer and the credit attribute range of the advertisement.

17. The system of claim 16, wherein the processor selects an advertisement for presentation to the consumer by determining that the credit attribute range of an advertisement includes the credit attribute of the consumer.

18. The system of claim 16, wherein the processor selects an advertisement for a predetermined number of consumers even though the consumers' corresponding credit attributes are not within the credit attribute range for the advertisement.

19. The system of claim 16, wherein the advertisement is in the form of a banner advertisement.

20. The system of claim 16, wherein the advertisement data includes banded pricing for offers such that different ranges of consumer credit attributes result in different offer prices.
